(19) United States
(12) Patent Application Publication
(10) Pub. No.: US 2025/0221324 A1
(43) Pub. Date: Jul. 10, 2025

(54) Open-Faced Bevel Tine Ejection Tip Aerator

(71) Applicant: Andrew Brenden Laplante, Mount Laurel, NJ (US)

(72) Inventor: Andrew Brenden Laplante, Mount Laurel, NJ (US)

(21) Appl. No.: 18/407,869

(22) Filed: Jan. 9, 2024

(51) Int. Cl. A01B 1/24

(52) U.S. Cl. CPC A01B 1/243

(57) ABSTRACT

A novel hollow tine aerator has been developed that features a bevel tip and bevel ejection system for enhanced soil penetration and seamless soil core removal. This innovative design addresses the limitations of conventional aerators, enabling efficient soil aeration and improved turfgrass health. The bevel tip design, with its inclined cutting edge, minimizes resistance and facilitates smoother penetration of hard or compacted soil. The bevel ejection system, comprising an angled base on top of the tine, guides the soil core upwards and exits through the open groove, eliminating the need for manual intervention. The integration of the bevel tip and bevel ejection system offers several benefits over conventional aerator designs. Enhanced soil penetration enables deeper aeration, promoting root growth and nutrient uptake. Seamless soil core removal eliminates the need for manual dislodgement, saving time and labor. Reduced operator fatigue enhances comfort and efficiency during aeration tasks.

### CROSS REFERENCE TO RELATED APPLICATION

This application claims the benefit under 35 U.S.C. § 119 (e) of U.S. Provisional Patent Application Ser. No. 63/438,066 filed on Feb. 3, 2023, entitled “Open-Faced Bevel Tine Ejection Tip Aerator” which is incorporated by reference in its entirety.

### FIELD OF THE DISCLOSURE

The present disclosure generally relates to lawn or soil aeration device and more particularly to a hollow tine aeration device.

### BACKGROUND

A hollow aerator is a type of core aerator that removes plugs of soil from the ground and leaves behind hollow holes. These hollow holes provide additional space for air and water to enter the root zone. The open-faced bevel tine ejection tine aerator design improves soil penetration by utilizing a 45-degree cut into the aerator tip.

### SUMMARY OF INVENTION

The present invention relates to a hollow tine aerator with a bevel tip and bevel ejection system. The bevel tip design allows for easier penetration of the soil, while the bevel ejection system seamlessly removes soil cores from the tines, reducing soil compaction and improving aeration. The bevel tip design features an inclined cutting edge that gradually transitions into the tine. This design facilitates smoother soil penetration, even in hard or compacted conditions. The bevel ejection system comprises an angled base on top of the tine that aligns with the bevel tip. As the aerator is pushed through the soil, the soil core encounters the angled base and is guided upwards, exiting the tine through the open channel. The present invention provides a hollow tine aerator with a system that addresses the limitations of conventional aerators. It helps in improving aeration efficiency and reducing operator fatigue. The invention offers a valuable solution for maintaining healthy turfgrass and improving soil conditions.

### BRIEF DESCRIPTION OF THE DRAWINGS

For a more complete understanding of this disclosure, reference is now made to the following description, taken in conjunction with the accompanying drawings, in which:

FIG. 1. Is a close look on the hollow tine to show its different parts.

FIG. 2. Depicts a blow-up view to illustrate how the tine is attached to the handle.

FIG. 3. Is a breakdown of the larger components that make up the anatomy of the current state of the whole device.

### DETAILED DESCRIPTION

The Open-Faced Bevel design of the preferred embodiment facilitates easier penetration of hard or compacted soil, improving aeration efficiency. The bevel ejection system eliminates the need for manual dislodgement of soil cores from the tines, reducing labor and enhancing overall efficiency. The hollow tine design allows for the removal of soil cores, promoting better aeration and drainage of the soil, which can lead to improved turfgrass health.

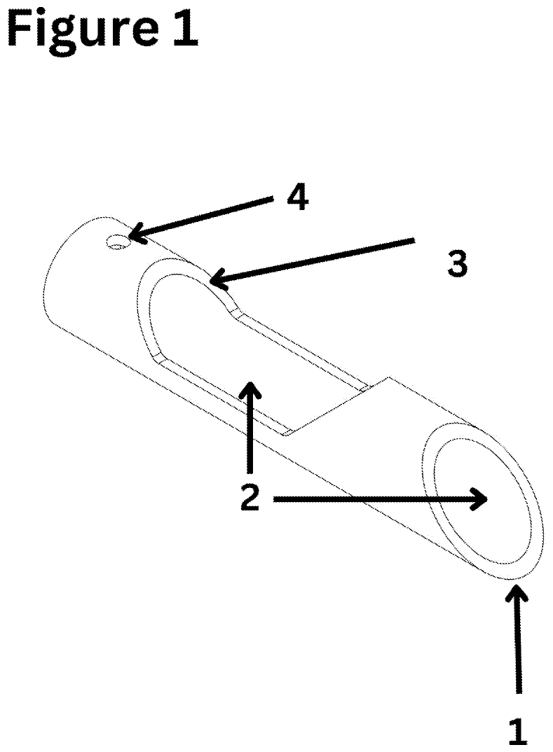

FIG. 1 depicts a hollow tine aerator according to an embodiment of the present disclosure. The open-faced bevel ejection tine is made from a 304 stainless steel welded cylinder at 5.12 inches in total length with a beveled deviation 3 near the top of the cylinder cut diagonally 45 degrees. The open-face design 2 is cut into the side of the aerator tip spanning a length of 2.743 inches from the middle. On the top of the aerator tip body is a slotted hole 4 used to attach the aerator to the ejection tip that is welded to the aerator handle body The screw hole 4 serves as the anchor point for the tine's attachment to the aerator handle. Its precise placement ensures a secure connection that facilitates seamless operation. Adjacent to the screw hole is the open hollow core 2, providing an unobstructed view of the tine's functionality. This open design enables the user to monitor the tine's penetration into the soil as well as forming a vertical channel through which extracted soil cores are ejected. Bevel 3 lies at the heart of the tine. This hollow core design enhances aeration efficiency, allowing for the removal of compacted soil and promoting better water infiltration. Complementing the hollow core is the bevel tip 1, a slanted edge that tapers from the tine's base to its tip. This bevel tip design facilitates smoother penetration of the soil, especially in compacted or hard-packed areas. The combination of these meticulously engineered components, all crafted from durable stainless steel, results in a robust and efficient aerator tine that effectively aerates the soil and enhances the overall performance of the aerator.

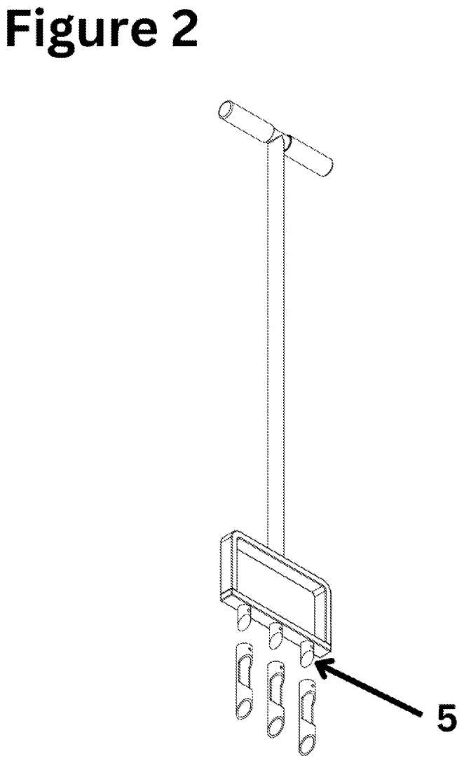

FIG. 2 which illustrates the ejection tip 5 where the tines would be anchored to. This is welded to the aerator body that provides a sturdy base. These points of attachment 5 are also cut in a 45-degree angle to eject the soil easily while the aerator is getting pushed down.

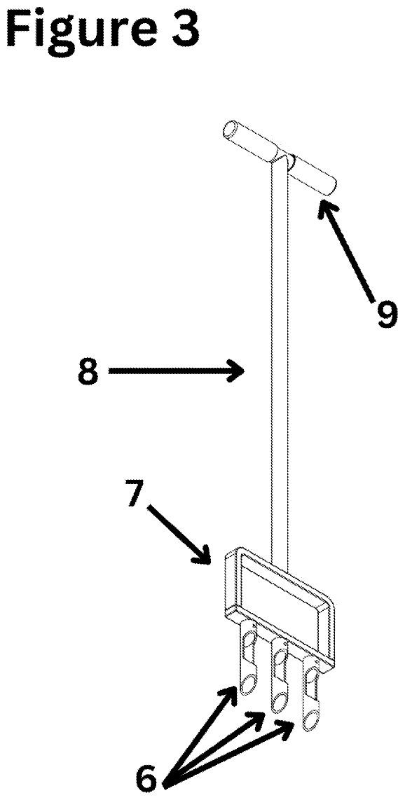

The preferred iteration of the design, referring to FIG. 3, shows a simplistic breakdown of the entirety of the aerator in which the aerator tines will be attached. The handle 9 is made of metal and has textured grips. The grips of the handle help the user to push the aerator into the ground with more force. The handle 9 is also long enough to provide the user with good leverage. The step 7 is made of metal and is a small, square, open platform welded on the connecting rod 8. The user can step inside to push the aerator into the ground with more force. The connecting rod 8 is made of metal and is short and sturdy. It connects the handle to the tines. The connecting rod is strong enough to withstand the force of the user pushing the aerator into the ground and at the very tip are the hollow tines 6. The three hollow tines are made of stainless steel and have a hollow core. The tines are sharp at the end and are used to remove plugs of soil from the ground. The hollow cores of the tines allow the soil to be aerated and drained more effectively. The tines 6 are also spaced evenly apart to ensure that the aeration is even.

While the current explanation and its benefits have been extensively outlined, it's important to recognize that variations, substitutions, and modifications can be implemented without deviating from the essence and extent of the explanation as outlined in the attached claims. Additionally, the scope of this application isn't confined to specific embodiments of processes, machinery, products, compositions, means, techniques, or steps detailed in the specification. Those skilled in the field will understand that existing or future processes, machinery, products, compositions, means, techniques, or steps that accomplish essentially the same function or result as the described embodiments can be employed in line with this explanation. Thus, the attached claims aim to encompass such processes, machinery, products, compositions, means, techniques, or steps within their scope.

1. A hollow tine aerator comprising:
a handle for pushing the aerator through the ground;
a plurality of tines, each having a bevel tip and bevel ejection system; and
a bevel tip.

2. The hollow tine aerator of claim 1, wherein the bevel ejection system comprises an angled base on top of the tine that guides the soil core upwards and exits through the open face.

3. The hollow tine aerator of claim 2, the bevel ejection system portion further comprising:
a screw hole for receiving a hardware to mount the tines to base.

4. The hollow tine aerator of claim 1, wherein the bevel tip design has an inclined cutting edge that gradually transitions into the tine's shaft.

5. The hollow tine aerator of claim 1, wherein the bevel tip design and bevel ejection system are integrated into the hollow tine design.

6. The hollow tine aerator of claim 5, wherein the bevel tip design and bevel ejection system significantly enhance aeration efficiency, reducing operator fatigue and streamlining the aeration process.
